(19) United States
(12) Patent Application Publication
(10) Pub. No.: US 2025/0367792 A1
(43) Pub. Date: Dec. 4, 2025

(54) PAIR OF GEAR HANDLE LEVER LABOR-SAVING PLIERS

(71) Applicant: Suzhou Wenheyu Tools Technology Co., Ltd, Suzhou (CN)

(72) Inventor: YU ZHOU, Cangzhou (CN)

(21) Appl. No.: 18/781,449

(22) Filed: Jul. 23, 2024

(30) Foreign Application Priority Data
Jun. 3, 2024 (CN) 202421241295.7

(51) Int. Cl. B25B 7/12; B25B 7/22

(52) U.S. Cl. CPC B25B 7/12; B25B 7/22

(57) ABSTRACT

Disclosed is a pair of gear handle lever labor-saving pliers, relating to an improvement of a daily use tool, and in particular to an improvement of a pair of labor-saving pliers. The pair of pliers includes a first jaw, a second jaw, a first handle, and a second handle, where the first jaw and the first handle are an integral structure, and the first jaw and the second jaw are hinged via a hinge pivot; a downward outer tooth part is provided at the transition between the first jaw and the first handle, a handle tooth part is provided at the top of the second handle, and the handle tooth part meshes with the outer tooth part; an upper part of the second handle is hinged to the second jaw through a second hinge pivot. The pair of pliers offers strong gripping force and cutting force.

### CROSS-REFERENCE TO RELATED APPLICATIONS

This application claims priority to Chinese Patent Application No. 202421241295.7, filed on June 03, 2024, which is hereby incorporated by reference in its entirety.

### TECHNICAL FIELD

The present disclosure relates to an improvement of a daily use tool, and in particular to an improvement of a pair of labor-saving pliers.

### BACKGROUND

The tool pliers used in daily life generally include jaws and handles. The jaws are mounted on the handles. When in use, the hand holds the handles to apply force, so that the jaws or scissors heads are gripped to achieve gripping or cutting. The existing tool pliers, however, rely on the handles of the pliers and the intermediate hinge pivot to achieve gripping and cutting through certain leverage. The gripping force and cutting force depend on the handles and the intermediate hinge pivot to achieve the effect of leverage, whereas the magnitude of the gripping force and cutting force heavily relies on the length and strength of the handles.

However, the handles and jaws of ordinary household pliers are of limited length, thus imposing significant restrictions on the gripping force and cutting force during practical use. Many application scenarios require substantial gripping force and cutting force in practical use, which ordinary pliers struggle to deliver.

### SUMMARY

An object of the present disclosure is to solve the defects and deficiencies of the prior art and provide a pair of gear handle lever labor-saving pliers, which offers strong gripping force and cutting force. By integrating a lever onto the pair of pliers, it achieves labor-saving effects. With a smaller gripping force, it can deliver strong gripping force and cutting force, enhancing the usability of the ordinary pair of pliers and expanding their application scenarios.

To achieve the above object, the present disclosure adopts the following technical solutions. The pair of gear handle lever labor-saving pliers includes a first jaw 1, a second jaw 2, a first handle 3, and a second handle 4. The first jaw 1 and the first handle 3 are an integral structure, and the first jaw 1 and the second jaw 2 are hinged via a hinge pivot 5. A downward outer tooth part 31 is provided at the transition between the first jaw 1 and the first handle 3, a handle tooth part 41 is provided at the top of the second handle 4, and the handle tooth part 41 meshes with the outer tooth part 31. An upper part of the second handle 4 is hinged to the second jaw through a second hinge pivot 6.

Flat grips 11 are correspondingly formed at the middle of the top of the first jaw 1 and the second jaw 2, pipe grips 12 are arranged at a lower part of the flat grips 11, and cutters 13 are arranged at a lower part of the pipe grips 12. The flat grips 11 may be used for gripping an article; the pipe grips 12 may be used for fastening or loosening a nut; the cutters 13 may be used for cutting a wire, an iron wire, or to strip a rubber or plastic insulating layer of cord.

The upper part of the second handle 4 is arranged with a groove 42, the handle tooth part 41 is arranged at the top of the groove 42, and the second jaw 2 is overlapped on an inner surface of the groove 42.

A wire gripping part 14 is provided at a lower part of a hinge of the first handle 3 and the second handle 4. The wire gripping part 14 may be used for twisting wires together.

The working principle of the present disclosure is as follows: based on the dual functions of linesman pliers and scissors of the existing pliers, one of the handles of the pair of pliers is divided into a movable handle and a fixing pivot; the top of the movable handle is engaged with an outer tooth part at the bottom of the first jaw 1 via a tooth top to form a rotating part; in gripping and cutting, by using the rotation and holding of the first handle 3, and using the rotation of the first handle 3 to form the effect of leverage, a stronger gripping force and cutting force are formed under the condition that a smaller holding force is required, to achieve the effect of saving force, large gripping force, and large cutting force.

With the above technical solutions, the beneficial effects of the present disclosure are as follows: the pair of pliers offers strong gripping force and cutting force. By integrating a lever onto the pair of pliers, it achieves labor-saving effects. With a smaller gripping force, it can deliver strong gripping force and cutting force, enhancing the usability of the ordinary pair of pliers and expanding their application scenarios.

### BRIEF DESCRIPTION OF DRAWINGS

To explain the embodiments of the present disclosure or the technical solutions in the prior art more clearly, the drawings used in the embodiments or the description of the prior art will be briefly introduced below. It is obvious that the drawings in the following description are only some embodiments of the present disclosure, and those ordinarily skilled in the art would have been able to obtain other drawings according to these drawings without creative work.

FIG. 1 is a structural diagram of the present disclosure;

FIG. 2 is a rear view of FIG. 1;

FIG. 3 is a structural diagram of a second handle 4 of the present disclosure after being fully unfolded;

FIG. 4 is a structural diagram of the second handle 4 of FIG. 3 after being rotated inwardly; and

FIG. 5 is a structural diagram of the present disclosure in a gripped state.

Description of reference numerals: 1, first jaw; 2, second jaw; 3, first handle; 4, second handle; 5, hinge pivot; 31, outer tooth part; 41, handle tooth part; 6, second hinge pivot; 11, flat grip; 12, pipe grip; 13, cutter; 42, groove; and 14, wire gripping part.

### DETAILED DESCRIPTION OF THE EMBODIMENTS

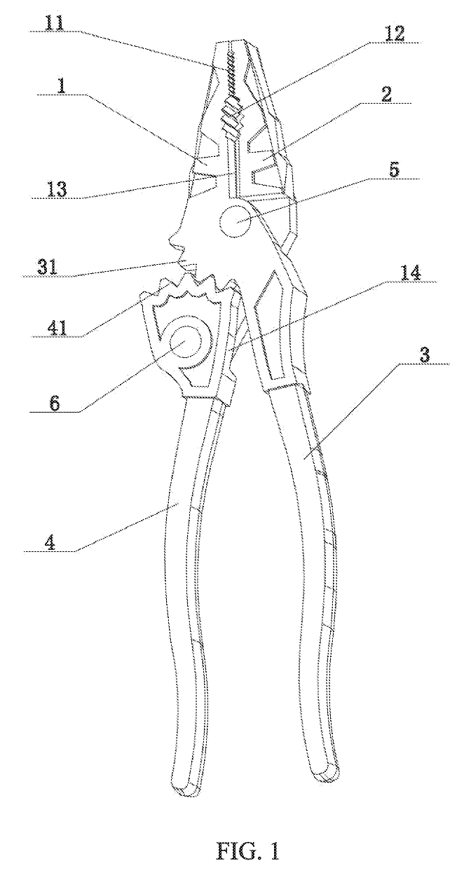

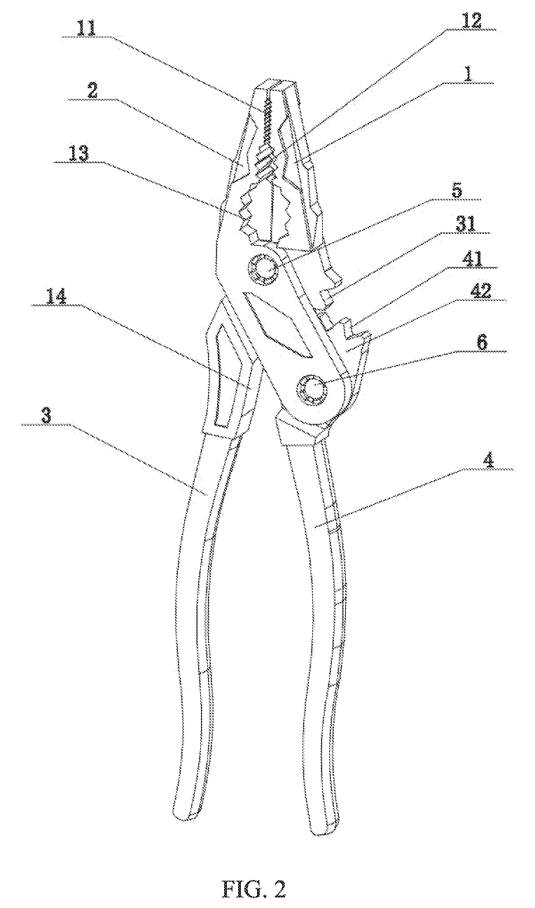

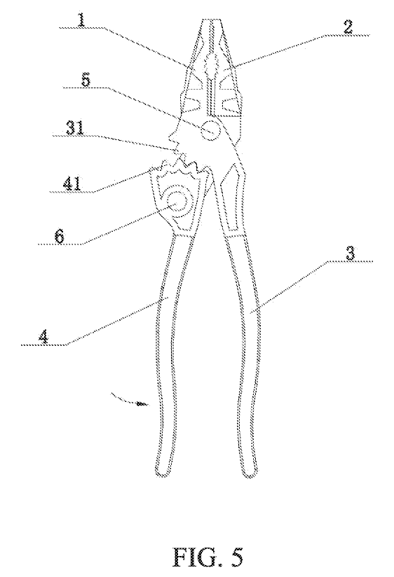

Referring to FIGS. 1 to 5, the technical solutions adopted by the implementation are as follows. The pair of gear handle lever labor-saving pliers includes a first jaw 1, a second jaw 2, a first handle 3, and a second handle 4. The first jaw 1 and the first handle 3 are an integral structure, and the first jaw 1 and the second jaw 2 are hinged via a hinge pivot 5. Flat grips 11 are correspondingly formed at the middle of the top of the first jaw 1 and the second jaw 2, pipe grips 12 are arranged at a lower part of the flat grips 11, and cutters 13 are arranged at a lower part of the pipe grips 12. The flat grips 11 may be used for gripping an article; the pipe grips 12 may be used for fastening or loosening a nut; the cutters 13 may be used for cutting a wire, an iron wire, or to strip a rubber or plastic insulating layer of cord. A downward outer tooth part 31 is provided at the transition between the first jaw 1 and the first handle 3, a handle tooth part 41 is provided at the top of the second handle 4, and the handle tooth part 41 meshes with the outer tooth part 31; an upper part of the second handle 4 is hinged to the second jaw through a second hinge pivot 6. The upper part of the second handle 4 is arranged with a groove 42, the handle tooth part 41 is arranged at the top of the groove 42, and the second jaw 2 is overlapped on an inner surface of the groove 42. A wire gripping part 14 is provided at a lower part of a hinge of the first handle 3 and the second handle 4. The wire gripping part 14 may be used for twisting wires together.

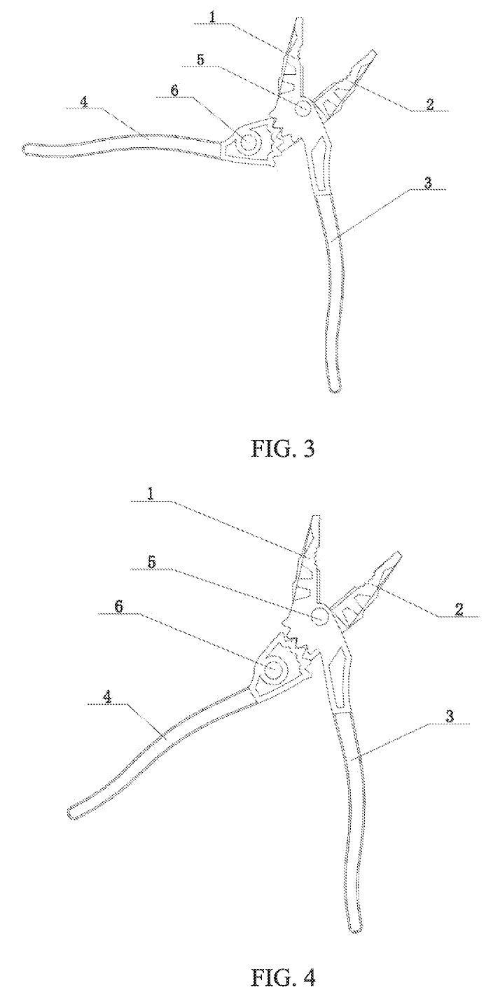

In the implementation, based on the dual functions of linesman pliers and scissors of the existing pliers, one of the handles of the pair of pliers is divided into a movable handle and a fixing pivot; the top of the movable handle is engaged with an outer tooth part at the bottom of the first jaw 1 via a tooth top to form a rotating part; in gripping and cutting, by using the rotation and holding of the first handle 3, and using the rotation of the first handle 3 to form the effect of leverage, a stronger gripping force and cutting force are formed under the condition that a smaller holding force is required, to achieve the effect of saving force, large gripping force, and large cutting force. Reference is made to FIGS. 3 to 5 for specific gripping and cutting variations.

After adopting the above technical solutions, the pair of pliers offers strong gripping force and cutting force. By integrating a lever onto the pair of pliers, it achieves labor-saving effects. With a smaller gripping force, it can deliver strong gripping force and cutting force, enhancing the usability of the ordinary pair of pliers and expanding their application scenarios.

The above description is merely illustrative of the technical solutions of the present disclosure and is not intended to be limiting. Other modifications and equivalent replacements made to the technical solutions of the present disclosure by those skilled in the art should be included in the scope of the claims of the present disclosure as long as they do not depart from the spirit and scope of the technical solutions of the present disclosure.

What is claimed is:

1. A pair of gear handle lever labor-saving pliers, comprising a first jaw (1), a second jaw (2), a first handle (3), and a second handle (4), wherein the first jaw (1) and the first handle (3) are an integral structure, and the first jaw (1) and the second jaw (2) are hinged via a hinge pivot (5); a downward outer tooth part (31) is provided at the transition between the first jaw (1) and the first handle (3), a handle tooth part (41) is provided at the top of the second handle (4), and the handle tooth part (41) meshes with the outer tooth part (31); an upper part of the second handle (4) is hinged to the second jaw through a second hinge pivot (6).

2. The pair of gear handle lever labor-saving pliers according to claim 1, wherein flat grips (11) are correspondingly formed at the middle of the top of the first jaw (1) and the second jaw (2), pipe grips (12) are arranged at a lower part of the flat grips (11), and cutters (13) are arranged at a lower part of the pipe grips (12).

3. The pair of gear handle lever labor-saving pliers according to claim 1, wherein the upper part of the second handle (4) is arranged with a groove (42), the handle tooth part (41) is arranged at the top of the groove (42), and the second jaw (1) is overlapped on an inner surface of the groove (42).

4. The pair of gear handle lever labor-saving pliers according to claim 1, wherein a wire gripping part (14) is provided at a lower part of a hinge of the first handle (3) and the second handle (4).
